(19) United States
(12) Patent Application Publication
(10) Pub. No.: US 2024/0426404 A1
(43) Pub. Date: Dec. 26, 2024

(54) SYSTEM AND METHOD FOR PIPE REPLACEMENT REPAIR

(71) Applicant: SAUDI ARABIAN OIL COMPANY, Dhahran (SA)

(72) Inventor: Ahmad Alakkas, Dhahran (SA)

(73) Assignee: SAUDI ARABIAN OIL COMPANY, Dhahran (SA)

(21) Appl. No.: 18/341,247

(22) Filed: Jun. 26, 2023

(51) Int. Cl. F16L 13/02; F16L 55/11

(52) U.S. Cl. CPC F16L 13/02; F16L 55/11

(57) ABSTRACT

A system and method for a pipe replacement and repair system. The system includes a first pipe section, a second pipe section connected to the first section, and a weld plus end device disposed around the first and second pipe sections defining a welding location. The weld plus end device includes seals configured to seal the weld plus end device to the first pipe section and the second pipe section. The seals include a first set of seals and a second set of seals affixed to the first pipe section. The seals further include a third set of seals and a fourth set of seals affixed to the second pipe section. The system further includes a screw test point between each of the first set of seals and each of the third set of seals configured to be a vent for testing the welding location.

### BACKGROUND

In the field of oil and gas, it is common for pipes to acquire wear and tear, leaks, rust, cracks, and unsalvageable damage. For safety purposes and effectiveness, damaged pipes require pipe replacement and repair. Pipe replacement and repair refers to the process of removing and replacing a damaged pipe section in the system in order to repair or replace the pipe. During pipe replacement and repair, it is common for the two pipes to be welded together for sealing purposes. Improper sealing of the pipes can result in leaks, breakage, and unsafe conditions. Conducting critical activities, such as welding operations, in the field can significantly increase dangers in safety, especially with hydrocarbons present. Accordingly, there exists a need for additional barriers and monitoring of seal testing during pipe replacement.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to pipe replacement and repair system, the system comprising: a first pipe section; a second pipe section connected to the first pipe section; a weld plus end device disposed around the first pipe section and the second pipe section defining a welding location, wherein the weld plus end device comprises a plurality of seals configured to seal the weld plus end device to the first pipe section and the second pipe section, wherein the plurality of seals comprises a first set of seals at a first radial location affixed to the first pipe section and a second set of seals at a first radially opposite location affixed to the first pipe section, wherein the plurality of seals comprises a third set of seals at a second radial location affixed to the second pipe section and a fourth set of seals at a second radially opposite location affixed to the second pipe section; and a screw test point between each of the first set of seals and each of the third set of seals, wherein the screw test point is configured to be a vent for testing the welding location.

In one aspect, embodiments disclosed herein relate to a pipe replacement and repair method, the method comprising: connecting a first pipe section to a second pipe section; attaching, around the first pipe section and the second pipe section, a weld plus end device comprising a plurality of seals configured to seal the weld plus end device to the first pipe section and the second pipe section, wherein the weld plus end device attached around the first pipe section and the second pipe section defines a welding location, wherein the plurality of seals comprises a first set of seals at a first radial location affixed to the first pipe section and a second set of seals at a first radially opposite location affixed to the first pipe section, wherein the plurality of seals comprises a third set of seals at a second radial location affixed to the second pipe section and a fourth set of seals at a second radially opposite location affixed to the second pipe section, wherein the weld plus end device comprises a screw test point between each of the first set of seals and each of the third set of seals; performing, via the screw test point, a seal test of the welding location; and performing a welding operation to the welding location.

Other aspects and advantages of the claimed subject matter will be apparent from the following description and the appended claims.

### BRIEF DESCRIPTION OF DRAWINGS

FIG. 1 shows an exemplary pipeline system in accordance with one or more embodiments.

FIG. 2 shows a system in accordance with one or more embodiments.

FIG. 3 shows a flowchart in accordance with one or more embodiments.

### DETAILED DESCRIPTION

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In one aspect, embodiments disclosed herein relate to a pipe replacement and repair system. In some embodiments, an existing pipe may include a damaged pipe section. The damaged pipe section is removed and replaced with a new pipe section. The new pipe section is then attached to the existing pipe to be seal tested and welded.

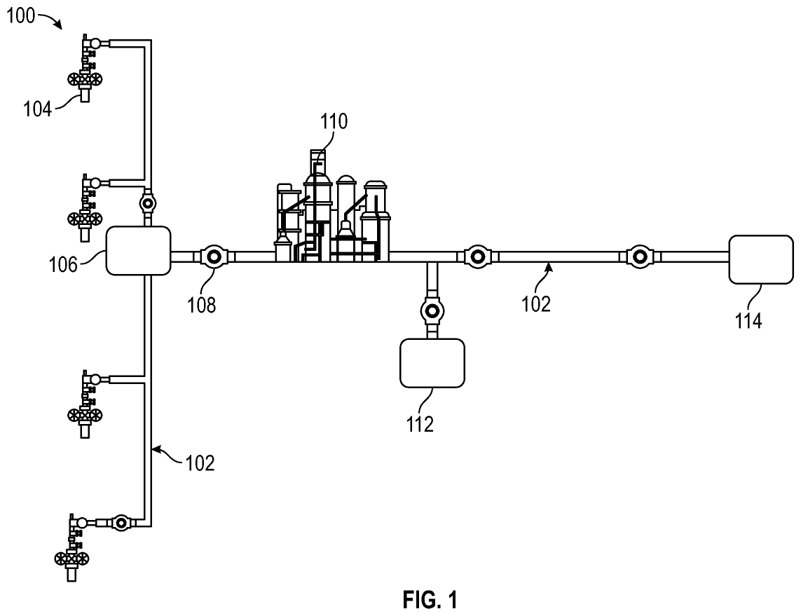

FIG. 1 shows an exemplary pipeline system in accordance with one or more embodiments. FIG. 1 depicts one illustrative example of how pipelines (102) may be employed and arranged in oil and gas operations. In the examples depicted herein, pipelines (102) are depicted as a gathering pipeline system (100), e.g., as commonly employed in the oil and gas industries, but could also represent a pipeline found in any of a great variety of other conceivable physical settings or operating contexts. For example, the pipelines (102) may be in systems, such as but not limited to petroleum transportation.

In some embodiments, the pipeline (102) is employed in a system employed for gathering hydrocarbons from production wells. In one example, the system includes pipelines (102) used for gathering hydrocarbons from wellheads (104) to a storage tank (106). Storage tanks (106) may be containers or reservoirs for temporary holding products, such as oil and gas. Storage tanks (106) may be above ground, semi subterranean, or subterranean. The wellheads (104) may be connected through pipelines (102) to a great variety of equipment positioned on-site, such as pump stations (108). Pump stations (108) may be used to maintain flow and pressure of hydrocarbons for transportation. The pipelines (102) may be used to transport hydrocarbons to a plant (110), such as a refinery or chemical plant. Pipelines (102) in gathering systems may be tens of hundreds of miles in length to cross state and continental borders. The pipelines (102) may transport refined products from the plant (110), such as gasoline, kerosene, and petrochemicals. The plants (110) may be connected through pipelines (102) to a variety of end users, such as storage facilities (112) and distribution terminals (114).

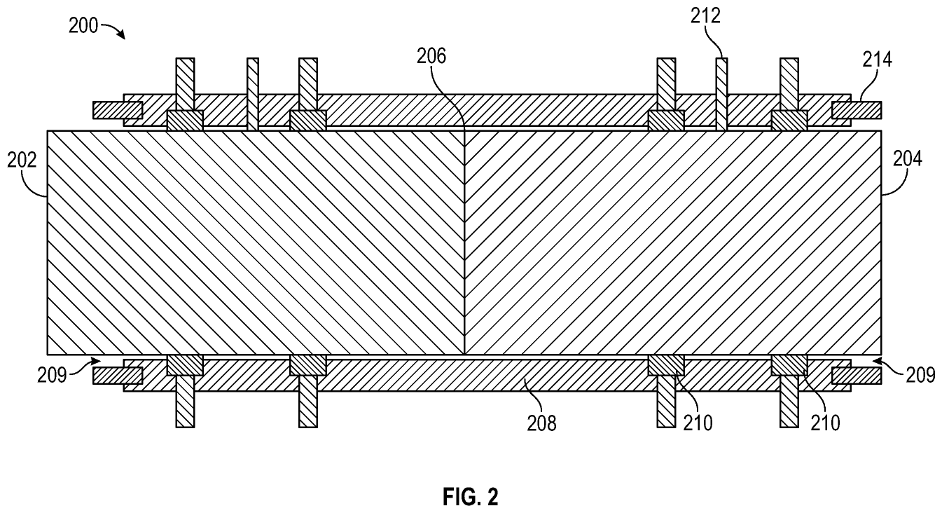

FIG. 2 shows a system in accordance with one or more embodiments. Specifically. FIG. 2 shows a pipe replacement and repair system (200). FIG. 2 shows an existing pipe section (202) and a new pipe section (204). The existing pipe section (202) may be a part of the pipeline (102) shown in FIG. 1. Either of the existing pipe section (202) and new pipe section (204) may be considered a “first” pipe section and the other may be considered a “second” pipe section. The existing pipe section (202) may be cold cut to remove a defective section of pipe before connecting to the new pipe section (204). The existing pipe section (202) connected to the new pipe section (204) defines a connecting section (206). The connecting section (206) is the connection between the existing pipe section (202) and the new pipe section (204). The connecting section (206) may be a conventional welding section. If welded, the connecting section (206) may cause a fire as heat and fuel are present in the area of the connecting section (206).

A weld plus end device (208) is disposed around the existing pipe section (202) and new pipe section (204) to join the two pipe sections. In one or more embodiments, the weld plus end device (208) is welded onto, or otherwise permanently kept on, the existing pipe section (202) and new pipe section (204). The area between the weld plus end device (208), the existing pipe section (202), and the new pipe section (204) defines a welding location (209), as illustrated in FIG. 2. The welding location (209) may be welded by permanently welding the weld plus end device (208) with the existing pipe section (202) and the new pipe section (204) by means of heat, pressure, or both. The welding location (209) may apply to each end of the weld plus end device (208). One end of the weld plus end device (208) may be welded to the existing pipe section (202) in one area of the welding location (209). The other end of the weld plus end device (208) may be welded to the new pipe section (204) in another area of the welding location (209). The weld plus end device (208) may act as an additional barrier and coupling to connect the existing pipe section (202) to the new pipe section (204). Fluid flow may resume before the welding location (209) is welded when the weld plus end device (208) is in place. The weld plus end device (208) includes a plurality of seals (210). The seals (210) are configured to seal the weld plus end device (208) to the existing pipe section (202) and the new pipe section (204). The seals (210) may be used to double block and bleed to ensure welding activity is safe to perform. During double block and bleed practice, the seals (210) shut in one section of pipe on both sides in order to bleed any pressure that remains in the pipe. The weld plus end device (208) may include a plurality of bolts (214) as illustrated in FIG. 2. The bolts (214) may be any fasteners capable of applying force on the seals (210) to hold pressure when tightened.

The seals (210) may include a first set of seals at a radial location affixed to the existing pipe section (202) and a second set of seals at a radially opposite location affixed to the existing pipe section (202). The seals (210) may include a third set of seals at a radial location affixed to the new pipe section (204) and a fourth set of seals affixed to the new pipe section (204) at a radially opposite location. By using a set of seals, two seals may be in each direction of a replacement location of the existing pipe section (202) and the new pipe section (204). A person of ordinary skill in the art may appreciate that each direction of the seals (210) include upstream and downstream directions. For example, the set of seals are double seals. The double seals may allow seal tests.

The weld plus end device (208) may include a screw test point (212) between each of the first set of seals and each of the third set of seals. The screw test point (212) may be a pressure test point screwed into the weld plus end device (208). The screw test point (212) is designed to be a vent for seal testing the welding location (209). The welding location (209) may be tested before welding. The welding location (209) may be tested by a fluid, such as nitrogen, water, or air, using the screw test point (212). The weld plus end device (208) seals the welding location (209) to allow for seal testing with the screw test point (212) before welding. The screw test point (212) may be used to monitor sealing during welding. Monitoring methods may be utilized, such as soap tests, to visually identify gas leaks. Pressure gauges may be used to monitor pressure build up.

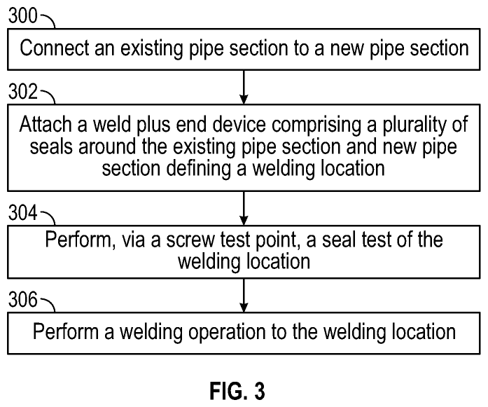

FIG. 3 shows a flowchart in accordance with one or more embodiments. Specifically, FIG. 3 describes a pipe replacement and repair method. One or more blocks in FIG. 3 may be performed by one or more components (e.g., weld plus end device (208)) as described in FIGS. 1 and 2. While the various blocks in FIG. 3 are presented and described sequentially, one of ordinary skill in the art will appreciate that some or all of the blocks may be executed in parallel. Furthermore, the blocks may be performed actively or passively.

Initially, in Block 300, a new pipe section (204) is connected to an existing pipe section (202). The existing pipe section (202) may be cold cut to remove a defective section of pipe before connecting to the new pipe section (204). In Block 302, a weld plus end device (208) comprising a plurality of seals (210) is attached around the existing pipe section (202) and the new pipe section (204) defining a welding location (209). The seals (210) are configured to seal the weld plus end device (208) to the existing pipe section (202) and the new pipe section (204). The seals (210) include four sets of seals. A first set of seals are affixed to the existing pipe section (202) at a radial location. A second set of seals are affixed to the existing pipe section (202) at a radially opposite location. A third set of seals are affixed to the new pipe section (204) at a radial location. A fourth set of seals are affixed to the new pipe section (204) at a radially opposite location. The weld plus end device (208) includes a screw test point (212) between each of the first set of seals and each of the third set of seals. A screw test point (212) may be located between any of the sets of seals (210). The seals (210) may be utilized to double block and bleed. The weld plus end device (208) may include a plurality of bolts (214) for applying force on the seals (210) as the bolts (214) tighten.

In Block 304, a seal test of the welding location (209) is performed via the screw test point (212). The seal test may be performed using a fluid, such as nitrogen, water, or air. In Block 306, a welding operation is conducted to the welding location (209). The welding operation may be performed on both ends of the welding plus end device (208). The weld plus end device (208) may monitor and seal test before, during, and after the welding operation.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed is:

1. A pipe replacement and repair system, the system comprising:
a first pipe section;
a second pipe section connected to the first pipe section;
a weld plus end device disposed around the first pipe section and the second pipe section defining a welding location,
wherein the weld plus end device comprises a plurality of seals configured to seal the weld plus end device to the first pipe section and the second pipe section,
wherein the plurality of seals comprises a first set of seals at a first radial location affixed to the first pipe section and a second set of seals at a first radially opposite location affixed to the first pipe section,
wherein the plurality of seals comprises a third set of seals at a second radial location affixed to the second pipe section and a fourth set of seals at a second radially opposite location affixed to the second pipe section; and
a screw test point between each of the first set of seals and each of the third set of seals,
wherein the screw test point is configured to be a vent for testing the welding location.

2. The system of claim 1, wherein the first pipe section is an existing pipe.

3. The system of claim 1, wherein the second pipe section is a new pipe.

4. The system of claim 1, wherein the plurality of seals are configured to double block and bleed.

5. The system of claim 1, wherein the welding location is tested by a fluid using the screw test point.

6. The system of claim 5, wherein the fluid is nitrogen.

7. The system of claim 5, wherein the fluid is water.

8. The system of claim 5, wherein the fluid is air.

9. The system of claim 1, wherein the weld plus end device comprises a plurality of bolts configured to apply a force on the plurality of seals.

10. A pipe replacement and repair method, the method comprising:
connecting a first pipe section to a second pipe section;
attaching, around the first pipe section and the second pipe section, a weld plus end device comprising a plurality of seals configured to seal the weld plus end device to the first pipe section and the second pipe section,
wherein the weld plus end device attached around the first pipe section and the second pipe section defines a welding location,
wherein the plurality of seals comprises a first set of seals at a first radial location affixed to the first pipe section and a second set of seals at a first radially opposite location affixed to the first pipe section,
wherein the plurality of seals comprises a third set of seals at a second radial location affixed to the second pipe section and a fourth set of seals at a second radially opposite location affixed to the second pipe section,
wherein the weld plus end device comprises a screw test point between each of the first set of seals and each of the third set of seals;
performing, via the screw test point, a seal test of the welding location; and
performing a welding operation to the welding location.

11. The method of claim 10, wherein the first pipe section is an existing pipe.

12. The method of claim 10, wherein the second pipe section is a new pipe.

13. The method of claim 10, wherein the plurality of seals are configured to double block and bleed.

14. The method of claim 10, wherein the seal test is performed using a fluid.

15. The method of claim 14, wherein the fluid is nitrogen.

16. The method of claim 14, wherein the fluid is water.

17. The method of claim 14, wherein the fluid is air.

18. The method of claim 10. further comprising applying a force on the plurality of seals via a plurality of bolts in the weld plus end device.
